(19) United States
(12) Patent Application Publication
(10) Pub. No.: US 2004/0208313 A1
(43) Pub. Date: Oct. 21, 2004

(54) Timed-release Cryptography

(76) Inventor: Wenbo Mao, Bradley Stoke (GB)

Correspondence Address: Hewlett-Packard Company, Intellectual Property Administration, PO Box 272400, Fort Collins, CO, 80527-2400, US

(21) Appl. No.: 10/468,687

(22) PCT Filed: Feb. 19, 2002
(86) PCT No.: PCT/GB02/00701

(30) Foreign Application Priority Data
Feb. 20, 2001 (GB) 0104140.9

(51) Int. Cl. H04K 1/00

(52) U.S. Cl. 380/30

(57) ABSTRACT

A method by which a first computing entity can verify to a second computing entity that a value a(t) provided by the first computing entity to the second computing entity is a member of the language, L(a,t,n) where L(a,t,n)=(a,t,a^{2t})(modn)|t<n,gcd(a,n)=1), where n is an odd composite integer having two distinct prime factors, (aΣZn*ₙ) of the full order and t<n, the method comprising: the first computing entity sends a set of values to the second computing entity during a run of a procedure of a plurality of rounds, each round being carried out by the first and second computing entities with respect to three of said series of values, denoted a,x,y and in which round the first computing entity proves to the second computing entity by way of a proof that there exists a k for which x=a^{2k} (modn) and y=a^{(2k)2} (modn), and which proof defines a new set of three values of the series by defining y=x if k in the current round is even or (y=√x) (modn) if k in the current round is odd, this round of steps being successively repeated until the new set of values defined by a round of steps satisfy x=a²(modn). We argue the necessity for zero-knowledge proof of the correctness of such constructions and propose the first practically efficient protocol for a realisation. The protocol according to the present invention proves, in log₂ₜ, standard crypto operations the correctness of a^{e2t} (modn) with respect to a^{e} where e is an RSA encryption exponent. With such a proof, a Timed-release RSA Encryption of a message M can be given as a^{2t} M(modn) with the assertion that the correct decryption of the RSA ciphertext M^{e}(modn) can be obtained by performing t squarings modulo n starting from a. Timed-release RSA signatures can be constructed analogously.

### TECHNICAL FIELD

The present invention relates to timed-release cryptography.

### BACKGROUND OF THE INVENTION

### 1 General Considerations

Let n be a large composite natural number. Given t<n and gcd(a,n)=1, without factoring n, the validation of

X≡a²^{^{t}}(mod n) (1)

can be done in t squarings mod n. However if φ(n) (Euler's phi function of n) is known, then the validation can be completed in O(logn) multiplications via the following two steps:

U=2^{t}(modφ(n))[definition], (2)

X=a^{u}(mod n)[definition], (3)

For t<<n (eg, n>2¹⁰²⁴ and t<2¹⁰⁰) it can be anticipated that factoring of n (and hence computing φ(n) for performing the above steps) will be much more difficult than performing t squarings. Under this condition we do not know any other method which, without using the factorisation information of n, can compute a²^{^{t}} (mod n) in time less than t squarings. Moreover, because each squaring can only be performed on the result of the previous squaring it is not known how to speedup the t squarings via parallelisation of multiple processors. Parallelisation of each squaring step cannot achieve a great deal of speedup since a squaring step only needs a trivial computational resource and so any non-trivial scale of parallelisation of a squaring step is likely to be penalised by communication delays among the processors.

These properties suggest that the language

L(a,t,n)={(a,t,a²^{^{t}}mod n)|t<n,gcd(a,n)=1} (4)

forms a good candidate for the realisation of timed-release crypto problems. Rivest, Shamir and Wagner pioneered the use of this language in a time-lock puzzle scheme [11]. In their scheme a puzzle is a triple (t,a,n) and the instruction for finding its solution is to perform t squarings mod n starting from a which leads to a²^{^{t}} (mod n). A puzzle maker, with the factorisation knowledge of n, can construct a puzzle efficiently using the steps in (2) and (3) and can fine tune the difficulty for finding the solution by choosing t in the vast range. For instance, the MIT Laboratory for computer Science has implemented the time-lock puzzle of Rivest el al into “The LCS35 Time Capsule Crypto-Puzzle” and started its solving routine on 4^{th Apr.} 1999. It is estimated that the solution to the LCS35 Time Capsule Crypto-Puzzle will be found in 35 years from 1999, or on the 70 years from inception of the MIT-LCS [10].

1.1 Applications

Various applications have been proposed which utilize such properties. Boneh and Naor used a subset of L(a,t,n) (details to be discussed in section 1.2) and constructed a timed-release crypto primitive which they called “timed commitments” [3]. Besides several suggested applications they suggested an interesting use of their primitive for solving a long-standing problem in fair contract signing. A previous solution (due to Damgard [6]) for fair contract signing between two remote and mutually distrusted parties is to let them exchange signatures of a contract via gradual release of secrets. A major drawback with that solution is a weak fairness. Let us describe this weakness by using, for example, a discrete-logarithm based signature scheme. A signature being gradually released relates to a series of discrete logarithm problems with the discrete logarithm values to have gradually decreasing magnitudes. Sooner or later before the two parties completes their exchange, one of them may find himself in a position of extracting a discrete logarithm which is sufficiently small with respect to his computational resource. It is well-know (eg, the work of Van Oorschot and Wiener on the parallelised rho method [12]) that parallelisation is effective for extracting small discrete logarithms. So the resourceful party (eg, affordable with vast parallelisation) can abort the exchange at that point and wins an advanced position unfairly. Boneh and Naor suggested to seal signatures under exchange using elements in L(a,t,n). Recall the aforementioned non-parallelisable property for reconstructing the elements in L(a,t,n), a roughly equal time can be imposed for the both parties to open the sealed signatures regardless of their (maybe vast) difference in computing resources. In this way, they argued that a strong fairness for contract signing can be achieved. (However, as will be discussed in section 1.2, they did not solve the problem at all due to the absence of a verifiability.)

Applications suggested by Rivest et al [11] include:

A bidder in an auction wants to seal his bid so that it can only be opened after the bidding period is closed.

A homeowner wants to give his mortgage holder a series of encrypted mortgage payments. These might be encrypted digital cash with different decryption dates, so that one payment becomes decryptable (and thus usable by the bank) at the beginning of each successive month.

A key-escrow scheme can be based on timed-release crypto, so that the government can get the message keys, but only after a fixed, pre-determined period.

An individual wants to encrypt his diaries so that they are only decryptable after fifty years (when the individual may have forgot the decryption key).

1.2 Previous Work and Unsolved Problems

With the nice properties of L(a,t,n) a person is only half way through to the realisation of timed-release cryptography. In most imaginable applications where timed-release crypto may play a role, it is necessary for a problem constructor to prove (ideally in zero-knowledge) the correct construction of the problem (eg without a correctness proof, the strong fairness property of the fair exchange application is absent).

From the problem's membership in NP we know that there exists a zero-knowledge proof for a membership assertion regarding language L(a,t,n). Such a proof can be constructed via a general method (eg, the work of Goldrich et al [8]). However, the performance of a zero-knowledge proof in a general construction is not suitable for practical use. By the performance for a practical use is meant an efficiency measured by a small polynomial in some typical parameters (eg, the bit length of n). To the applicant's knowledge, there exists no practically efficient zero-knowledge protocols for proving a general case of membership in L(a,t,n) and say so with awareness of the work of Boneh and Naor of “timed commitments” [3].

Boneh and Naor constructed a practically efficient protocol for proving membership in a subset of L(a,t,n) where t=2^{k} with k being natural numbers. The time control that this subset can offer is in the granularities of powers of 2. These granularities are too coarse. Boneh and Naor envisioned k∈[30, . . . , 50] for typical cases in applications. While it is evident that k decreasing from 30 downwards will quickly trivialise a timed-release crypto problem as 2³⁰ is already at the level of a small polynomial in the secure bit length of n (usually 2¹⁰), a k increasing from 30 upwards will harden the problem in such increasingly giant steps that imaginable services (eg, the strong fairness for gradual disclosure of secret proposed in [3]) will quickly become unattractive or unusable. Taking the LCS35 Time Capsule for example, suppose that the 35-year-opening-time capsule is in that subset (so the correctness can be efficiently proved with their protocol), then the only other elements in that subset with opening times close to 35 years will be that of 17.5 years and that of 70 years, respectively.

Further to the problem of coarseness in time control, the correctness of a timed commitment in [3] (and that of other timed-release crypto primitives proposed in the same paper) depends on the honesty of the committer (the person who has constructed a timed commitment). In [3] a timed commitment for committing M is as follows: first u=∈L(a,2^{k},n) is proven; then, bit-by-bit, the bits of M are xor-ed to the successive square roots of u modulo n. So when u is uncovered from 2^{k} squarings modulo n starting from a, all those square roots have been uncovered and M is thereby de-committed. However, no proof whatsoever was available for the committer to show the correct xor-ing of the hidden bits of M to the hidden square roots of u. In absence of a correctness proof, such a construction cannot be regarded as a commitment in a cyrptographic sense.

Neither did the Time-Lock puzzle work of Rivest et al[11] provided a method for showing the correct construction of a timed-release crypto problem.

1.3 The Present Invention

The present invention, in a first aspect, provides a method by which a first computing entity can verify to a second computing entity that a value a(t) provided by the first computing entity to the second computing entity is a member of the language, L(a,t,n) where L(a,t,n)={(a,t, a²^{^{t}} (modn)|t<n, gcd(a,n)=1), where n is an odd composite integer having two distinct prime factors, a∈Znₙ* of the full order and t<n, the method comprising:

the first computing entity sends a set of values to the second computing entity during a run of a procedure of a plurality of rounds, each round being carried out by the first and second computing entities with respect to three of said series of values, denoted a, x, y, and in which round the first computing entity proves to the second computing entity by way of a proof that there exists a k for which x=a²^{^{k}} (modn) and y=a⁽²^{^{k}}⁾^{²} (modn), and which proof defines a new set of three values of the series by defining y=x if k in the current round is even or y=\sqrt{x} (modn) if k in the current round is odd,

this round of steps being successively repeated until the new set of values defined by a round of steps satisfy x=a²(modn).

The first computing entity (also “Alice” or “A”) can readily calculate the values a²^{^{k}}, a²^{^{k/2}} etc by virtue of secret knowledge of φ(n) and equations (2) and (3) and so produce the required values. This allows Alice to readily send the required series of values, which includes the above set of values, from which the second computing entity (“Bob” or “B”) can verify, from the fact the last value in the series is a² (ie a²^{^{t}}) that value a(t) is of the form a²^{^{t}} and so a member of the language L(a,t,n).

In this way Bob can verify the continuity of the chain of values in the set from a(t)(=a²^{^{t}}) to a²(=a²^{¹}) as sent by Alice as each value in the set is of the form a²^{^{k}}, for same k, and is verifiably followed by the value a²^{^{(k-1)/2}}, k odd, or k²^{^{k/2}}, k even, until a² is reached.

The zero-knowledge proof that each value received is equal to a value a²^{^{k/2}} may be based on a knowledge of a value a²^{^{k}} comprises the first computing entity selecting a value z:x≡±a^{z}(modn), y≡±a^{z}^{²} (modn), the second computing entity choosing at random r<n, s<n and sending the value C=a^{r}x^{s}(modn) to the first computing entity, the first computing entity sending to the second computing entity the value R=C^{z}(modn), and the second computing entity accepting the verification if, and only if, the received value R≡x^{r}y^{s}(modn).

A method according to the present invention may include the computer implemented first step of verifying by data exchanges between the computing entities that n is an odd composite of two distinct primes to a desired confidence level, and/or that the computer implemented step of verifying a∈Zₙ* of the full order.

The present invention in a second aspect provides a method by which a computing entity can provide that an RSA ciphertext M^{e}(modn) of a message M<n provided to another computing entity is verifiably decryptable in time t, where n=p.q, p and q being two distinct odd primes and e is relatively prime to φ(n), the method comprising the computer implemented steps of:

a) forming a(t)=a²^{^{t}}(mod n) and a^{e}(t)=(a(t))^{e}(modn), a not ≡±1(modn) and being a random element in Zₙ*;

b) forming TE(M,t)=a(t) M(modn),

c) sending the tuple (TE(M,t), a^{e}(t), e,a,t,n) to the other computer entity.

This method may include the other computing entity on receiving the tuple from the computing entity verifies that the RSA ciphertext m(modn) is decryptable from TE(MT) in time t by confirming a^{e}(t)∈L(a^{e},t,n) by a method according to the first aspect of the present invention and by confirming TE(M,t)^{e}≡a^{e}(t)M^{e}(modn).

The present invention in the third aspect provides a method by which a computing entity can provide that an RSA signature M^{d}(modn) on a message M<n provided to another computer entity is verifiably releasable in time t, where n=p.q, p and q being distinct odd primes and d is relatively prime to φ(n), the method comprising the computer implemented steps of:

a) forming a(t)=a²^{^{t}}(modn) and a^{e}(t)=(a(t))^{e}(modn); a not ≡±1 (modn) and being a random element in Zₙ*;

b) forming TS(M,t)=a(t)M^{d}(modn);

c) sending the tuple (M,TS(m,t), a^{e}(t),e,a,t,n) to the other computing entity.

This method may include the other computing entity on receiving the tuple from the computing entity verifies that the RSA signature M^{d}(modn) can be obtained from TS(M,t) in time t by confirming a^{e}(t)∈L(a^{e},t,n) by a method according to the first aspect of the present invention and by confirming TE(M,t)^{e}≡a^{e}(t)M^{e}(modn).

The present invention in a fourth aspect provides a computing entity comprising: a data processing equipment, a memory; and a communications equipment, said data processing equipment being configured so as to be capable of processing data according to a set of instructions stored in said memory; said communications equipment configured so as to communicate data according to said set of instructions; said set of instructions being such as to configure the computing entity to be capable of carrying out the computer implemented steps of any of the methods of the first aspect of the present invention and in a fifth aspect to a system of co-operating such computing entities, which computing entities may be part of a communication system and which are able to exchange data by way of a communications medium, and in which said communications medium includes one or more of any of the internet, local area network, wide area network, virtual private circuit or public telecommunications network.

The present invention in a sixth aspect computer storage medium having stored thereon a computer program readable by a general-purpose computer, the computer program including instructions for said general purpose computer to configure it to be as any computing entity according to the present invention.

The present invention in all its various aspects, is based on the provision of a practical zero-knowledge proof protocol for demonstrating the membership in L(a,t,n) which runs in log₂t steps each an exponentiation modulo n, or O(log₂)(log₂n)³) bit operations in total. This efficiency suits practical uses. The membership demonstration can be conducte in terms of (a^{e})^{2t}(modn)∈L(a^{e},t,n) on given a and a^{e} where e is an RSA encryption exponent. Then we are able to provide two timed-release crypto primitives, one for timed release of a message in RSA encryption, and the other for timed release of an RSA signature. In the former, a message M can be sealed in a²^{^{t}} M(modn) and the established membership asserts that the correct decryption of the RSA ciphertext M^{e}(modn) can be obtained by performing t squarings modulo n starting from a. The latter primitive can be constructed analogously.

The schemes of the present invention provide general methods for the use of timed-release cryptography.

Embodiments of the best mode invention contemplated by the applicant will now be described, by way of example only, with reference to the accompanying drawings of which:

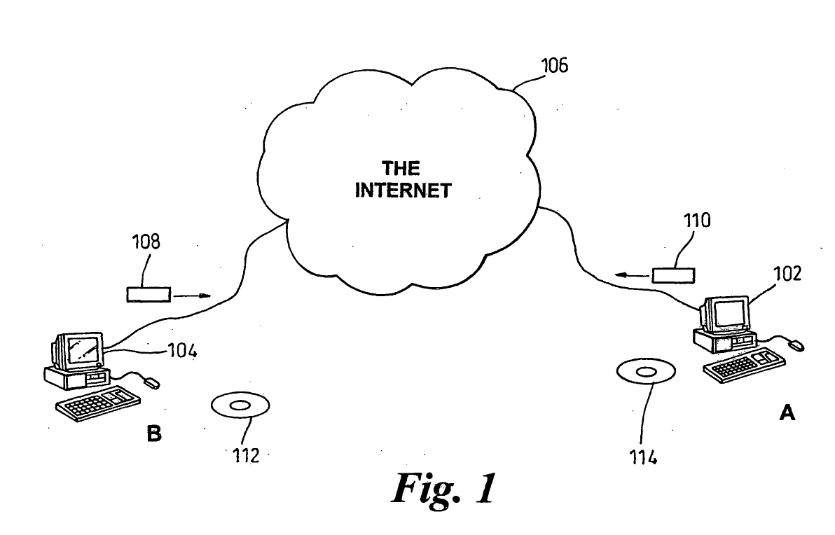

FIG. 1 is a schematic diagram of a system of co-operating computing entities according to the present invention;

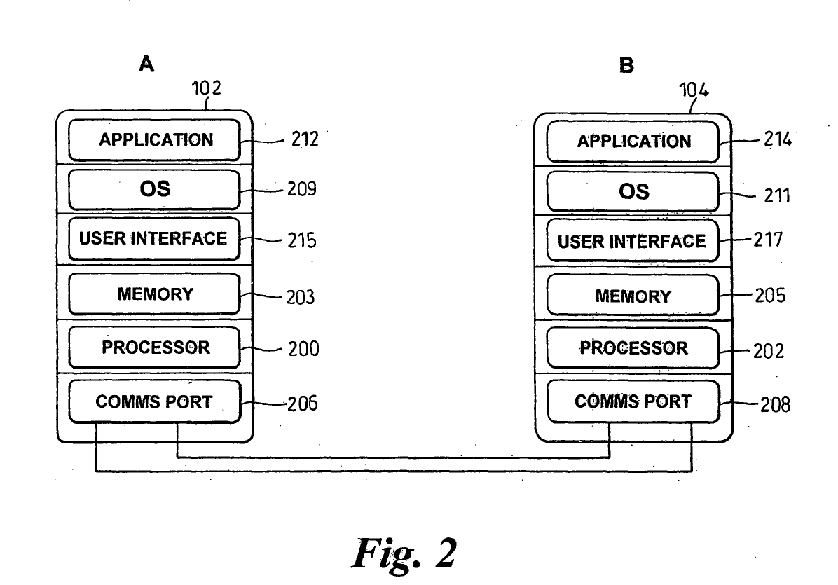

FIG. 2 is a schematic diagram of the computing entities of the system of computing entities of FIG. 1;

FIG. 3 is a pseudo-code description of the method of verifying a(t)∈L(a,t,n) of the present invention;

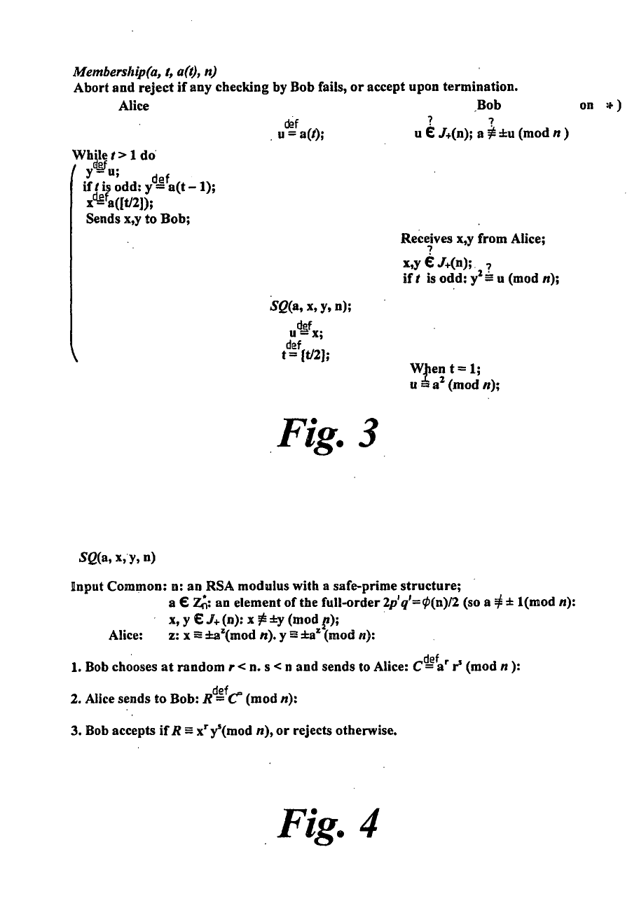

FIG. 4 is a pseudo-code description of a verification method useful with the method of FIG. 3;

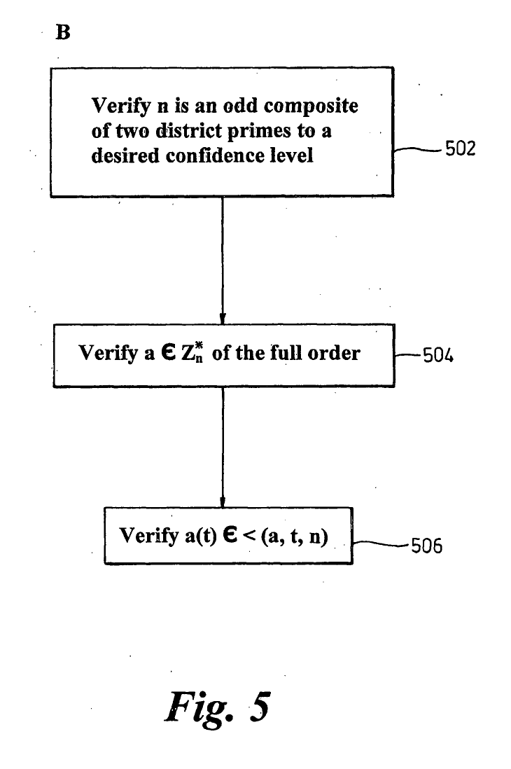

FIG. 5 is a flow chart of the additional verification steps useful with the present invention;

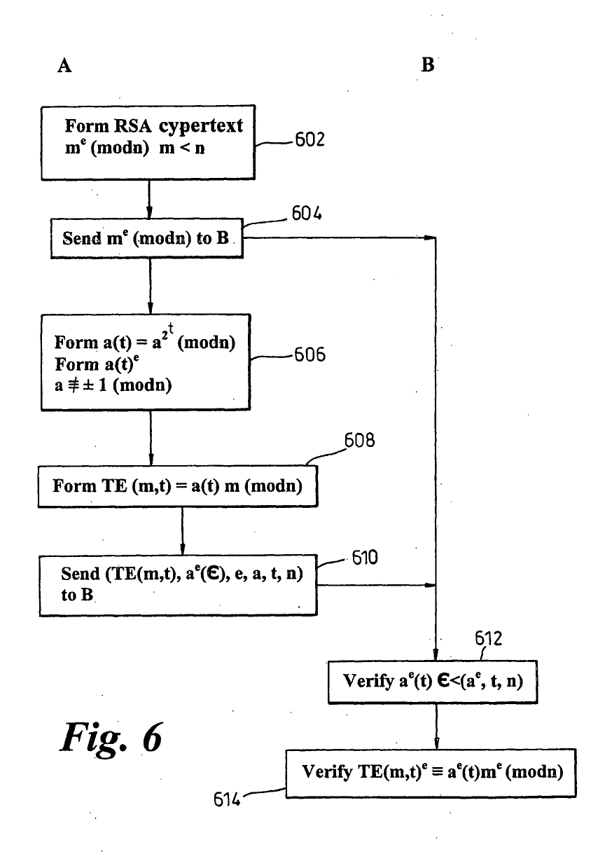

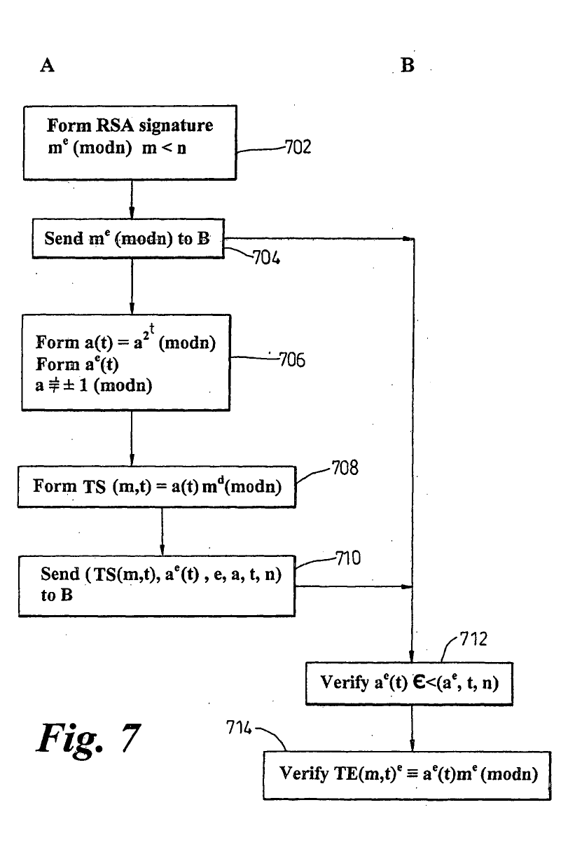

FIGS. 6 and 7 are flow charts of applications of the method according to the present invention.

### 1. DETAILED DESCRIPTION OF THE EMBODIMENTS

In the following description numerous specific details are set forth in order to provides a thorough understanding of the present invention. It will be apparent however, to one skilled in the art, that the present invention may be practiced without limitation to these specific details. In other instances, well-known methods and structures have not been described in detail so as not to unnecessarily obscure the present invention.

Referring to FIG. 1, there is illustrated schematically two computing entities 102, 104, configured for communicating electronic data with each other over a communications network, in this case the internet 106, by communicating data 108, 110, to each other via the internet 106 in well know manner. Illustrated in FIG. 1 is first computing entity 102, herein after referred to as entity A or Alice, a second computing entity 104 herein referred to as entity B or Bob. In the example illustrated in FIG. 1, the first and second computing entities 102 and 104 are geographically remote from each other and the communications network comprises the known internet 106. In other embodiments and implementations of the present invention the communications network could comprise any suitable means of transmitting digitized data between the computing entities. For example, a known Ethernet network, local area network, wide area network, virtual private circuit or public telecommunications network may form the basis of a communications medium between the computing entities 102 and 104.

The computing entities 102 and 104 have been programmed by storing on memories 203 and 205 programs read from computer program storage media 112 and 114, for example a CD-ROMs.

Referring now to FIG. 2, there is illustrated schematically physical resources and logical resources of the computing entities A and B. Each computing entity comprises at least one data processing means 200, 202 a memory area 203, 205, a communications port 206, 208 for communicating with other computing entities. There is an operating system 209, 211, for example, a known Unix operating system. One or more applications programs 22, 214 are configured for operating for receiving, transmitting and performing data processing on electronic data received from other computing entities, and transmitted to other computer entities in accordance with specific methods of the present invention. Optionally there is a user interface 215, 217 which may comprises a visual display device, a pointing device, eg. a mouse or track-ball device, a keypad, and a printer.

Under control of the respective application program 212, 214 each of the computing entities 102, 104 is configured to operate according to a method of the present invention, specific embodiments of which will now be described.

Referring now to FIG. 3, there is shown a pseudo-code flow description of the steps of an embodiment of the present invention by which a computing entity (B, Bob) may determine whether a(t)∈L(a,t,n) and which is described in more detail at following section 4.2.

Bob has received the values a,t,a(t),n and it is assumed that Alice and Bob have agreed on n being of suitable prime factor structure. At the start of the “membership” procedure U is defined as equal to a(t) and Bob verifies that U∈J₊(n) and that a is not ≡±U(modn).

Alice sets y to U and determines whether t is odd or even. If l is even Alice calculates x=a(t/2) and sends the values x and y to Bob. If t is odd, Alice sets t to t−1, sets y to a(t−1) and calculates x+a((t−1)/2) (ie a(k) where k=the integer portion of t/2) and sends these values to Bob.

In each case (t was odd or even) Bob verifies x, y∈J₊(n) and in the case t was odd verifies that y² is ≡u(modn).

Alice and Bob then enter into a data exchange SQ(a,x,y,n), to be described in more detail with reference to FIG. 4 by which Alice verifies to Bob that there exists an x such that x is ≡a^{z}(modn) and y is ≡a^{z}^{²}(modn). Thereafter n is redefined as the current value of t/2. If t=1 the membership procedure terminates and Bob verifies that U is ≡a²(modn) thereby verifying that a(t) is of the form a²^{^{t}}. If t>1, then Alice calculates the next value of x in the series to send to Bob.

Referring now to FIG. 4, there is shown a pseudo-code description of an SQ procedure mentioned above. Bob has values a and n, as well as values x and y supplied by Alice. Bob chooses values r and s and random t<n and s<n, calculates the value C=a^{r}x^{s}(modn) and sends this value to Alice. Alice then calculates the value R=C^{z}(modn) where z is such that x is ≡±a^{z}(modn) and y is ≡a^{z}^{²}(modn). Bob accepts the verification of T=x^{r}y^{s}(modn) and rejects it otherwise.

Referring to FIG. 5, there is shown a flow chart of a method of the present invention in which at step 502, B verifies that n is an odd composite of two distinct primes to a desired confidence level, then at step 504 verifies a∈ₙ* of the fall order before proceeding to verify, with the co-operation of Alice, that a(t)∈L(a,t,n) at step 506.

FIG. 6 is a flow chart of a method by which a computing entity can provide that an RSA ciphertext M^{e}(modn) of a message M<n provided to another computing entity is veriflably decryptable in time t, where n=p.q, p and q being two distinct odd primes and e is relatively prime to φ(n), the method comprising the computer implemented steps of:

a) forming a(t)=a²^{^{t}}(mod n) and a^{e}(t)=(a(t))^{e}(modn), a not ≡±1 (modn) and being a random element in Zₙ*;

b) forming TE(M,t)=a(t) M(modn),

c) sending the tuple (TE(M,t), a^{e}(t), e,a,t,n) to the other computer entity.

The other computing entity on receiving the tuple from the computing entity verifies that the RSA ciphertext m(modn) is decryptable from TE(M,t) in time t by confirming a^{e}(t)∈L(a^{e},t,n) by the method of the first aspect of the present invention and by confirming TE(M,t)^{e}≡a^{e}(t)M^{e}(modn).

FIG. 7 is a flow chart of a method by which a computing entity can provide that an RSA signature M^{d}(modn) on a message M<n provided to another computer entity is verifiably releasable in time t, where n=p.q, p and q being distinct odd primes and d is relatively prime to φ(n), the method comprising the computer implemented steps of:

a) forming a(t)=a²^{^{t}}(modn) and a^{e}(t)=(a(t))^{e}(modn); a not ≡±1(modn) and being a random element in Zₙ*;

b) forming TS(M,t)=a(t)M^{d}(modn);

c) sending the tuple (M,TS(m,t), a^{e}(t),e,a,t,n) to the other computing entity.

The other computing entity on receiving the tuple from the computing entity verifies that the RSA signature M^{d}(modn) can be obtained from TS(M,t) in time t by confirming a^{e}(t)∈L(a^{e},t,n) by the method of the first aspect of the present invention and by confirming TE(Mt)^{e}≡a^{e}(t)M^{e}(modn).

1.4 Organisation

In the next section we agree on notations to be used in the paper. In section 3 we construct general methods for timed release cryptography based on proved membership in L(a,t,n). In Section 4 we construct our membership proof protocol working with RSA modulus of a safe-prime structure. In Section 5 we generalise our result to working with any odd composite modulus which is difficult to factor.

### 2 Notation

Throughout the paper we use the following notation, Zₙ denotes the ring of integers modulo n. Zₙ* denotes the multiplicative group of integers modulo n. φ(n) denotes Euler's phi function of n. which is order, i.e., the number of elements, of the group Zₙ*. For an element of a∈Znₙ* Orderₙ(a) denotes the multiplicative order modulo n of a, which is the least index i satisfying aⁱ≡1 (mod n); (a) denotes the subgroup generated by a;(x/n) denotes the Jacobi symbol of x mod n. We denote by J₊(n) the subset of Zₙ*, containing the elements of the positive Jacobi symbol. For integers a, b, we denote by gcd(a,b) the greatest common divisor of a and b, and by Icm(a,b) the least common multiple of a and b. For a real number r, we denote by [r] the floor of r, i.e. r round down to the nearest integer. For an event E, we denote by Pr[E] the probability for E to occur.

### 3 Timed-Release Crypto with Membership In L(a, t, n)

Let Alice be the constructor of a timed-release crypto problem. She begins with constructing a composite natural number n=pq where p and q are two distinct odd prime numbers. Define

$$\begin{matrix}a ( t ) {=}^{def} {a}^{{2}^{t}} ( mod n ) , & ( 5 ) \\ {a}^{ⅇ} ( t ) {=}^{def} {( a ( t ) )}^{ⅇ} ( mod n ) , & ( 6 )\end{matrix}$$

where e is a fixed natural number relatively prime to φ(n) (in the position of an RSA encryption exponent), and a ≡±1 (mod n) is a random element in Zₙ*. Alice can construct a(t) using the steps in (2) and (3).

The following security requirements should be in place: n should be so constructed that Order_{100 (n)}(2) is sufficiently large, and a should be so chosen that Orderₙ(a) is sufficiently large. In the remainder of this section, we assume that Alice has proven to Bob, the verifier, the following membership status (using the protocol in §4):

a^{e}(t)∈L(a^{e}, t, n). (7)

Clearly, this is clearly equivalent to another membership status:

a(t)∈L(a, t, n).

However in the latter case a(t) is (temporarily) unavailable to Bob due to the difficulty of extracting the e-th root (of a^{e}(t))in the RSA group.

3.1 Timed-release of an RSA Encryption

For message M<n, to make the RSA ciphertext M^{e}(modn)decryptable in time t,Alice can construct a “timed encryption”:

$$TE ( M , t ) {=}^{def} a ( t ) M ( mod n ) . \qquad ( 8 )$$

Let Bob be given the tuple (TE(M, t), a^{e}(t), e, a, t, n) where a^{e}(t) is constructed in (5) and (6) and has the membership status in (7) proven by Alice. Then from the relation

TE(M,t)^{e}≡a^{e}(t)M^{e}(mod n), (9)

Bob is assured that the plaintext corresponding to the RSA ciphertext M^{e}(mod n) can be obtained from TE(M, t) by performing t squarings modulo n starting from a.

Remark As in the case of practical public-key encryption scheme, M in (8) should be randomised using a proper plaintext randomisation scheme designed for providing the semantic security (e.g., the OAEP scheme for RSA [1]).

3.2 Timed-Release of an RSA Signature

Let e, n be as above and d satisfy ed≡1 (mod φ(n))(so d is in the position of all RSA signing exponent). For message M<n (see Remark below), to make its RSA signature M^{d} (mod n) reasonable in time t, Alice can construct a “timed signature”:

$$TS ( M , t ) {=}^{def} a ( t ) {M}^{d} ( mod n ) . \qquad ( 10 )$$

Let Bob be given the tuple (M, TS(M, t), a^{e}(t), e, a, t, n)where a^{e}(t) is constructed in (5) and (6) and has the membership status in (7) proven by Alice. Then from the relation

TS(M,t)^{e}≡a^{e}(t)M(mod n), (11)

Bob is assured that the RSA signature on M can be obtained from TS(M, t) by performing t squarings modulo n starting from a.

Remark As in the case of a practical digital signature scheme, Min (10) should denote an output from a secure one-way hash function. We further require that the output is in J₊(n). A random padding scheme should make this happen with probability 0.5.

3.3 Security Analysis

3.3.1 Confidentiality of M in TE(M,t)

We assume that Alice has implemented properly our security requirements on the large magnitudes of Order_{φ(n)}(2) and Orderₙ(a). Then we observe that the mapping from a^{e} to a^{e}(t) is random (which follows the Blum-Blum-Shub random sequence generator [2]) in a large subset of the quadratic residues modulo n. Thus, given the difficulty of extracting the e-th root of random element in the RSA group, a successful extraction of a(t) from a^{e}(t) will constitute a grand breakthrough if it is done at a cost less than t squarings modulo n.

The above part of the argument(i.e., difficulty of finding a(t) from a^{e}(t)) will also apply to the security analysis in §3.3.3.

Next: we observe that our scheme for encrypting M∈Zₙ* inside TE(M,t) is a trapdoor one-way permutation (from Zₙ* to a subset of it) since the transformation is to multiply, modulo n, the message M to the trapdoor secret a(t). Thus, well-known plaintext ranomisation schemes which have been proposed for achieving the semantic security for trapdoor-one-way-permutation-based cryptosystems (e.g., OAEP for RSA [1]) can be applied to our plaintext message before the permutation and thereby achieve the message confidentiality properties that such a randomization scheme offers (against various passive or active attacks).

3.3.2 Unforgeability of M^{d} in TS(M, t)

Recall that M here denotes an output from a secure one-way hash function before signing in the RSA way. The unforgeability of M^{d} in TS(M,t) directly follows that of.M^{d}(mod n) given in clear.

Likewise, the randomness of a^{e}(t) ensures that of TS(M, t)^{e}. Thus the availability of the pair (TS(M, t), TS(M, t)^{e}) does not constitute a valid signature of Alice on anything since this availability is equivalent to that of (x, x^{e}) which can be constructed by anybody out of using a random x.

3.3.3 Indistinguishability of M^{d} in TS(M,t).

The indistinguishability is the following property: with the timed-release signature on M available at hand and with the proven membership a^{e}(t)∈L(a^{e}, t, n), but without going through t squarings mod n, Bob must not be able to show to a third party that the data he possesses form a signature of Alice on M. The holding of this property is shown below.

Let \hat{M}∈J₊(n) be any message of Bob's choice (e.g., \hat{M}^{d} becomes available to him from a different context). We have

$$TS ( M , t ) ≡ a ( t ) {M}^{d} ≡ a ( t ) {( \frac{M}{\hat{M}} )}^{d} {\hat{M}}^{d} ≡ \hat{a} {\hat{M}}^{d} ( mod n ) .$$

So the third party faces to decide which of M^{d} or \hat{M}^{d} is sealed in TS(M,t). This boils down to deciding if a(t)∈L(a, t, n) or â∈L(a, t, n) (both are in J₊(n)). Even by making a(t) and â available to the third party (and hence M^{d} and \hat{M}^{d} become available too), without having viewed the membership proof protocol run between Alice and Bob, a correct decision will form a grand breakthrough if it is done at a cost less than t squarings mod n. We should emphasise the following point: even though the availability of M^{d} and \hat{M}^{d} allows one to recognise that the both to be Alice's valid signatures, without verifying the membership status, one is unable to tell if any of the two has any connection with TS(M, t) at all.

### 4 Membership Proof with Safe-Prime-Structured Modulus

Let Alice have constructed her RSA modulus n with a safe-prime structure. This requires n=pq, p′=(p−1)/2, q′=(q−1)/2 where p, q, p′ and q′ are all distinct primes of roughly equal size.

We assume that Alice has proven to Bob in zero-knowledge such a structure of n. This can be achieved via using, e.g., the protocol of Camenisch and Michels [4].¹ 1 Due to the current difficulty of zero-knowledge proof for a safe-prime-structured RSA modulus, we recommend to use the protocol in section 5 which works with any odd composite modulus provided it is difficult to factor. Section 4 merely serves a preparation purpose for Section 5.

Let a∈Zₙ* satisfy

gcd(a±1, n)=1, (12)

[image]

$$( \frac{a}{n} ) = - 1. \qquad ( 13 )$$

It is elementary to show that a satisfying (12) and (13) has the full order 2p′q′. The following lemma observes a property of a.

Lemma 1 Let n be an RSA modulus of a safe-prime structure and a a∈Zₙ* of the full order. Then for any x∈Zₙ*, either x∈(a) or −x∈(a).

Proof It's easy to check −1∉(a). So (a) and the coset (−1)(a) both have the half the size of Zₙ*, yielding Zₙ*=(a)∪(−1)(a) Any x∈Zₙ* is either in (a) or in (−1)(a).

The latter case means −x∈(a).

4.1 A Building Block Protocol

Let Alice and Bob have agreed on n (this is based on Bob's satisfaction on Alice's proof that n has a safe-prime structure).

FIG. 1 specifies a perfect (zero-knowledge protocol for Alice to prove that for a, x, y∈Zₙ* with n of a safe-prime structure, a of the full order, and x, y∈J₊(n), they satisfy (note, ± below means either + or −, but not both)

∃z: x≡±a^{z}(mod n), y≡±a^{z}^{²}(mod n). (14)

Alice should of course have constructed a, x, y to satisfy (14). She sends a, x, y to Bob.

Bob (has checked n of a safe-prime structure) should first check (12) and (13) on a for its full-order property (the check guarantees a ≡±1 (mod n)); he should also check x,y∈J₊(n).

Remark For ease of exposition this protocol appears in a non zero-knowledge format

However, the zero-knowledge property can be added to it using the notion of a commitment function:

Instead of Alice'sending R in Step 2, she sends a commitment commit(R), after which Bob reveals r and s; this allows Alice to check the correct formation of C; the correct formation means that Bob has already known Alice's response.

Theorem 1 Let a, x, y, n be as specified in the common input in Protocol SQ. The protocol has the following properties:

Completeness There exist z∈Zₙ and x, y∈Zₙ* satisfying (14); for these values Bob will always except Alice's proof,

Soundness If (14) does not hold for the common input then Alice, even computationally unbounded, cannot convince Bob to accept here proof with probability greater than

$$\frac{2 {p}^{′} + 2 {q}^{′} - 1}{2 {p}^{′} {q}^{′}} {.}^{2}$$

Zero-knowledge Bob gains no information about Alice's private input.

Proof

Completeness For any z∈Zₙ, let x=a^{z}(mod n), y=a^{z}^{²}(mod n) (both in the plus case). It is evident from inspection of the protocol that Bob will always accept Alice's proof.

Soundness Suppose that (14) does not hold whereas Bob has accepted Alice's proof. The first congruence of (14) holds as a result of Lemma 1. So it is the second congruence of (14) that does not hold. Let ξ∈Zₙ* satisfy

y≡ξa^{z}^{²}(mod n) with Orderₙ(ξ)>2. (15)

By asserting Orderₙ(ξ)>2 we exclude the cases for ξ being any square root of 1, which consists of either ±1, or the other two roots which will render y∉J₊(n).

We only need to consider the case x≡−a^{z}(mod n). The other case x≡a^{z}(mod n) is completely analogous (and easier).

Since Bob accepts the proof, he sees the following congruences

C≡a^{r}x^{s}(mod n), (16)

R≡x^{r}y^{s}(mod n). (17)

Examining (16), we see that C≡a^{r}(−x)^{s}∈(a) if s is even, or −C≡a^{r}(−x)^{s}∈(a) if s is odd. So for either cases of s, we are allowed to rewrite (16) into the following linear congruence with r and s as unknowns

logₐ±C≡r+sz(mod 2p′q′).

For every case of s=1,2, . . . , 2p′q′, this linear congruence has a value for r. This means that for any fixed C, (16) has exactly 2p′q′ pairs of solutions. Each of these pairs will yield an R from (17). Below we argue that for any two solution pairs from (16), which we denote by (r, s) and (r′, s′), if gcd(s−s′, 2p′q′)≦2 then they must yield R≢R′ (mod n). Suppose on the contrary

a^{r}x^{s}≡C≡a^{r′}x^{s′}(mod n), i.e., a^{r-r′}≡x^{s′-s}(mod n), (18)

it also holds

x^{r}y^{s}≡R≡R′≡x^{r′}y^{s′}(mod n), i.e., x^{r-r′}≡y^{s′-s}(mod n). (19)

Using (18) and (15) with noticing x≡−a^{z}, we can transform (19) into

(−1)^{[r-r′+z(s′-s)]}a^{[z}^{²}^{(s′-s)]}≡x^{r-r′}≡y^{s′-s}≡ξ^{(s′-s)}a^{[z}^{²}^{(s′-s)]}(mod n),

which yields

ξ^{(s′-s)}≡(−1)^{[r-r′+z(s′-s)]}≡±1(mod n), i.e., ξ^{2(s′-s)}≡1(mod n). (20)

Recall that Orderₙ(ξ)>2 which implies Orderₙ(ξ) being a multiple of p′ or q′ or both. However, gcd(s−s′, 2p′q′)≦2 i.e. gcd(2(s′−s)2p′q′)=2, so 2(s′−s) cannot be such a multiple. Consequently (20) cannot hold and we reach a contradiction.

For any s≦2p′q′, it's routine to check that there are 2p′+2q′−2 cases of s′ satisfying gcd(2(s′−s)2p′q′)>2. Thus, if(14) does not hold, amongst 2p′q′ possible R's matching the challenge C, there are in total 2p′+2q′−1 of them (matching s and the other 2p′+2q′−2s′s) that may collide to Bob's fixing of R. Even computationally unbounded, Alice will have at best

$$\frac{2 {p}^{′} + 2 {q}^{′} - 1}{2 {p}^{′} {q}^{′}}$$

probability to have responded correctly.

Zero-Knowledge Immediate (see Remark after the description of the protocol).

4.2 Proof of Membership in L(a, t, n)

For t≧1, we can express 2^{t} as

$${2}^{t} = \{ \begin{matrix}{2}^{[ 2 \cdot ( t / 2 ) ]} = {[ {2}^{( t / 2 )} ]}^{2} & if t is even \\ {2}^{[ 2 \cdot ( t - 1 ) / 2 + 1 ]} = {[ {2}^{( t - 1 ) / 2} ]}^{2} \cdot 2 & if t is odd\end{matrix}$$

Copying this expression to the exponent position of a²^{^{t}}(mod n), we can express

$${a}^{{2}^{t}} ( mod n ) ≡ \{ \begin{matrix}{a}^{{[ {2}^{( t / 2 )} ]}^{2}} & if t is even \\ {( {a}^{[ 2 ( t - 1 ) / 2 ]} )}^{2} & if t is odd\end{matrix} \qquad ( 21 )$$

In (21) we see that the exponent 2^{t} can be expressed as the square of another power of 2 with t being halved in the latter. This observation suggests that repeatedly using SQ, we can demonstrate, in └log₂ t┘ steps, that the discrete logarithm of an element is of the form 2^{t}. This observation translates precisely into the protocol specified in FIG. 2 which will terminate within log₂ t steps and prove the correct structure of a(t). The protocol is presented in three columns: the actions in the left column are performed by Alice, those in the right column, by Bob, and those in the middle, by the both parties.

A run of Membership(a,t,a(t),n) will terminate within └log₂ ┘ loops, and this is the completeness property. The zero-knowledge property follows that of SQ. We only have to show the soundness property.

Theorem 2 Let,=(2p′+1)(2q′+1) be an RSA modulus of a safe-prime structure, a∈Zₙ* be of the full order 2p′q′, and t>1. Upon acceptance termination of Cert_Est(a, t, a(t),n), relation a(t)≡a²^{^{t}}(mod n)probability greater than

$$1 - \frac{⌊ {log}_{2} t ⌋ ( 2 {p}^{′} + 2 {q}^{′} - 1 )}{2 {p}^{′} {q}^{′}} .$$

Proof Denote by SQ((a, x₁, y₁, n) and by SQ(a, x₂, y₂, n) any two consecutive acceptance calls of SQ in Membership (so y₁=a(t) in the first call, and x₂=a² in the last call, of SQ in Membership, respectively). When t>1, such two calls prove that there exists z:

x₂≡±a^{z}(mod n), y₂≡±a^{z}^{²}(mod n), (22)

[image]

and either

x₁=y₂≡±a^{z}^{²}(mod n), y₁≡±a^{z}^{⁴}(mod n), (23)

or

=y₂²≡a^{2z}^{²}(mod n), y₁≡±a^{4z}^{⁴}(mod n). (24)

Upon t=1, Bob further sees that x₂=a². By induction, the exponents z,(resp. z², z⁴, 2z², 4z⁴) in an cases of ±a^{z} (resp. ±a^{z}^{²}, . . . ) in (22), (23) or (24) contain a single factor: 2, and the minus symbol disappears from (22), (23) and (24) since the even exponents imply all cases of x and y to be quadratic residues.

So we can write a(t)=a²^{^{u}}(mod n) for some natural number u. Further note that each all of SQ causes an effect of having 2^{u} square-rooted in the integers which is equivalent to having u halved in the integers. Thus, exactly └log₂u┘ calls (and no more) of SQ can be made. Bob has counted └log₂ t┘ calls of SQ, therefore u=t.

Each acceptance call of SQ has the correctness probability

$$1 - \frac{2 {p}^{′} - 2 {q}^{′} - 1}{2 {p}^{′} {q}^{′}} .$$

So after └log₂ t┘ acceptance calls of SQ, the probability for Membership to be correct is

$${( 1 - \frac{2 {p}^{′} + 2 {q}^{′} - 1}{2 {p}^{′} {q}^{′}} )}^{⌊ {log}_{2} t ⌋} > 1 - \frac{⌊ {log}_{2} t ⌋ ( 2 {p}^{′} + 2 {q}^{′} - 1 )}{2 {p}^{′} {q}^{′}} . \qquad □$$

Discussions

i) It is obvious that by preparing all the intermediate values in advance, Membership, can be run in parallel to save the └log₂ t┘ rounds of interactions.

ii) In our applications described in §3, we will always prove a^{e}(t)∈L(a^{e}, t, n) where e satisfies gcd(e, φ(n))=1 (i.e., e is an RSA encryption exponent). Thus, a^{e} preserves the frill order property to allow proper running of SQ and Membership.

iii) In case of proving the correctness of a(t) with an intention for a reconstruction to be done in t squarings (e.g., reconstruction of a(t−1) to be done in t−1 squarings), we should note that a run Membership (a, t, a(t), n) has caused disclosure of a(└t/2┘) for even t and a(t−1) for odd t. This disclosure allows the reconstruction to be done in t/2 or 0 squarings, respectively. To compensate the loss of computation, proof of (2t) is necessary. Consequently, Membership (a, 2t, a(2t), n) runs one more loop than Membership (a, t, a(t), n) does. Note that this precaution is unnecessary for our applications in §3 because there it is the e-th root of the disclosed value that is needed but is not available still.

4.3 Performance

In each run of SQ, Alice (resp. Bob) performs one (resp. four) exponentiations(s) mod n. Membership (a, 2t, a(2t), n) Alice (resp. Bob) will perform └log₂ t┘ (resp. 4└log₂ t┘) exponentiations mod n. These translate to O(└log₂ t┘(log₂ n)³) bit operations.

In the LCS35 Time Capsule Crypto-Puzzle [10], t 79685186856218 is a 47-bit binary number. Thus the verification for that puzzle can be (completed within 4×47=188 exponentiations mod n.

The number of bits to be exchanged is measured by O((└log₂ t┘)(log₂ n)).

5 Membership Proof with General Modulus

Now we show that our membership proof protocol can work with a modulus which is any odd composite integer provided it has two distinct prime factors (so factoring can be difficult). Our trick is to work with n² and prove

a(t)∈L(a, t, n²)

where a (t) is constructed modulo n² (to be specified in (25) and (26) below). Once the above is proven: a(t) (mod n)∈L(a, t, n) results straightforwardly.

We begin by presenting a lemma which observes an interesting property of elements in Zₙ_{²}* where n is any odd composite integer with at least two distinct prime factors. (Paillier used the same group to have new public-key cryptosystems (9), which does not use our observation.)

Lemma 2 Let n be any odd composite integer. For a randomly chosen integer u∈Zₙ_{²}*,

$$Pr [ n divides {Order}_{{n}^{2}} ( u ) ] \geq \frac{φ ( n )}{n} .$$

Proof See Appendix A.

[image]

5.1 Modified Membership Proof Protocol

Let Alice have constructed a(t) (mod n²). She can do so efficiently by the following two steps

$$\begin{matrix}u {=}^{def} {2}^{t} ( mod φ ( n ) n ) , & ( 25 ) \\ a ( t ) {=}^{def} {a}^{u} ( mod {n}^{2} ) . & ( 26 )\end{matrix}$$

The building-block protocol SQ will be modified into SQ2 in FIG. 3 which allows Alice to prove that a common input tuple (a, x, y, n) satisfies

∃z: x≡a^{z}(mod n²) and y≡a^{z}^{²}(mod n²) (27)

The modified protocol will require a∈Zₙ_{²}* to have an order divisible by n. By Lemma 2, if a is output from a pseudo random generator which is seeded with n and a publicly verifiable seed, then this will almost certainly be the case. This way of fixing a can be verified by Bob. Also, we assume that x is in the orbit of a (as will be clear in a moment, this will always be seen by Bob in his verification which applies SQ2).

Of course, Bob should check x≢±a (mod n²) before engaging a verification run with Alice.

Remark Besides the use of n², SQ2 differs from SQ in Step 2 where Alice adds a proof of subgroup membership, which is very simple (see e.g., Stinson [12], pages 399-400) and can be made non-interactive.

We only have to prove the soundness property for SQ2.

Theorem 3 Let a, x, y, n be as specified in the common input of Protocol SQ2. The protocol has the following properties soundness property:

Soundness If (27) does not hold for the common input values, then Alice cannot convince Bob to accept her proof with probability greater than

$$\frac{n - φ ( n ) + 1}{n} {.}^{3}$$

Proof See Appendix A.

Replacing SQ with SQ2 and n with n², Membership is modified straightforwardly to working with n². Upon acceptance, Bob sees that when t=1, x has an initial value generated by a. By the soundness property of SQ2, y will have an initial value generated by a using a power of 2, which has been used as the value of x in a previous loop. By induction, this status (x∈(a)) will be maintained as long as Bob has accepted each run of SQ2. Thus after └log₂ t┘ instances of acceptance of SQ2, the modified Membership has a correctness probability greater than

$$1 - \frac{⌊ {log}_{2} t ⌋ ( n - φ ( n ) + 1 )}{n} .$$

Finally we should recap that Bob's acceptance of a(t)∈L(a, t, n²) implies his acceptance of a(t) (mod n)∈L(a, t, n). The timed-release encryption and signature schemes in §3 should remain working with modulo n, rather than n².

5.2 Performance

In SQ2, the additional step for verifying the subgroup membership condition will require Bob to compute an additional modulo exponentiation, while Alice's load remains the same. So Bob will compute 5 modulo exponentiations mod n².

The use of a modulus of double size will result in a 8-fold increase in local computations. Thus, to prove (resp. verify)a(t)∈L(a, t, n²)using the modified membership proof protocol, Alice (resp. Bob) will perform 8(└log₂ t┘) (resp. (5×8) (└log₂ t┘)) exponentiations mod n. (These measurements have been converted to the modulo n operation.)

### 6 Conclusion

We have constructed general and efficient cryptographic protocol schemes for achieving timed-release cryptography which include timed-release encryption and timed-release signatures. These schemes have proven correctness on time control which can be fine tuned to the granularity in the number of multiplications.

We have also shown that the use of n² can relax the structural requirement on n. This is an important observation which indicates that many RSA-based protocols which require the use of safe-prime structured moduli can be modified this way to working with standard moduli. Therefore this observation forms an independent contribution to the area of study.

### References

[1] Bellare, M., Desai, A., Pointcheval, D. and Rogaway, P. Relations among notions of security key encryption schemes, Advances in Cryptology: Proceedings of CRYPTO 98 (H. Krawczyk ed.), Lecture Notes in Computer Science 1462, Springer-Verlag 1998, pages 26-45.

[2] Blum, L., Blum, M. and Shub, M. A simple unpredictable pseudo-random number generator, SIAM J. Comput 15(2): 364-383 (1986).

[3] Boneh, D. and Naor, M. Timed commitments (extended abstract), Advances in Cryptology: Proceedings of CRYPTO'OO, Lecture Notes in Computer Science 1880, Springer-Verlag 2000, pages 236-254.

[4] Camenisch J. and Michels, M. Proving in zero-knowledge that a number is the product of two safe primes, In Advances in Cryptology—EUROCRYPT 99 (J. Stern ed.), Lecture Notes in Computer Science 1592, Springer-Verlag 1999, pages 106-121.

[5] Chaum, D. Zero-knowledge undeniable signatures, Advances in Cryptology Proceedings of CRYPTO 90 (I. B. Damgaard, ed.) Lecture Notes in Computer Science 473, Springer-Verlag 1991, pages 458-464.

[6] Damg\dot{a}rd, I. Practical and probably secure release of a secret and exchange of signatures, Advances in Cryptology—Proceedings of EUROCRYPT 93 (T. Helleseth ed. , Lecture Notes in Computer Science 765, Springer-Verlag 1994. pages 200-217.

[7] Gennaro, R., Krawczyk, H. and Rabin, T. RSA-based undeniable signatures, Advances in Cryptology: Proceedings of CRYPTO 97 (W. Fumy ed.), Lecture Notes in Computer Science 1294, Springer-Verlag 1997. pages 132-149 Also in Journal of Cryptology (2000)13:397-416.

[8] Goldreich, O, Micali, S. and Wigderson, A. How to prove all NP statements in zero-knowledge and a methodology of cryptographic protocol design, Advances in Cryptology—Proceedings of CRYPTO 86 (A. M. Odlyzko ed.), Lecture Notes in Computer Science, Springer-Verlag 263 (1987), pages 171-185.

[9] Paillier, P. Public-key cryptosystems based on composite degree residuosity classes, Advances in Cryptology—Proceedings of EUROCRYPT 99 (J. Stern ed.), Lecture Notes in Computer Science, Springer-Verlag 1592 (1999), pages 223-238.

[10] Rivest, R. L. Description of the LCS35 Time Capsule Crypto-Puzzle, http://www.lcs.mit.edu/about/tcapintro041299, Apr. 4th, 1999.

[11] Rivest, R. L., Shamir, A. Wagner, D. A. Time-lock puzzles and timed-release crypto, Manuscript. Available at (http://theory.lcs.mit.edu/˜rivest/RivestShamirWagner-timelock.ps).

[12] Stinson, D. R. Cryptography: Theory and Practice, CR.C Press, 1995.

[13] van Oorschot, P. C. and Weiner, M. J. Parallel collision search with cryptanalytic applications, J of Cryptology, Vol.12, No.1 (1999), pages 1-28.

A Proofs

Lemma 2 Let n be any odd composite integer. For a randomly chosen integer u∈Zₙ_{²}*,

$$Pr [ n divides {Order}_{{n}^{2}} ( u ) ] \geq \frac{φ ( n )}{n} .$$

Proof Write n=Πᵢ^{r}=1^{r}pᵢ^{e}^{ᵢ} with pᵢ (for i=1, 2, . . . , r) being distinct odd primes.

Let i=1,2 . . . , r.

For any x∈Zₙ_{²}* denote by χᵢ ∈

$${Z}_{{p}_{i}^{2 {e}_{i}}}^{*}$$

the result of x mod pᵢ^{2e}^{ᵢ}. Then x∈Zₙ_{²}* has an order divisible by n if and only if

$${Z}_{{p}_{i}^{2 {e}_{i}}}^{*}$$

xᵢ∈Z_{P}_{ᵢ}_{^{ze}}^{ᵢ}

has an order divisible by pᵢ^{e}^{ᵢ}, i.e., the order is pᵢ^{e}^{ᵢ}k for k|φ(pᵢ^{e}^{ᵢ}). In the cyclic group

$${Z}_{( {p}_{i}^{2 {e}_{i}} )}^{*}$$

the number elements of order pᵢ^{e}^{ᵢ}k.for k|φ(pᵢ^{e}^{ᵢ}). Summing them up for all the cages of k the number of such elements in the

$${Z}_{( {p}_{i}^{2 {e}_{i}} )}^{*} ,$$

is

$${\sum }_{{p}_{i}^{{e}_{i}} k \vert φ ( {p}_{i}^{2 {e}_{i}} )} φ ( {p}_{i}^{{e}_{i}} k ) \geq φ ( {p}_{i}^{{e}_{i}} ) {\sum }_{k \vert φ ( {p}_{i}^{{e}_{i}} )} φ ( k ) = {φ ( {p}_{i}^{{e}_{i}} )}^{2} .$$

The inequality meets the equation case only when gcd(φ(n), n)=1 and thereby φ(pᵢk)=φ(pᵢ)φ(k). Thus, in Zₙ_{³}*, the number of elements of orders divisible by n is at least

$${\prod }_{i = 1}^{r} {φ ( {p}_{i}^{{e}_{i}} )}^{2} = {φ ( {\prod }_{i = 1}^{r} {p}_{i}^{{e}_{i}} )}^{2} = {φ ( n )}^{2} .$$

The claimed probability bound follows from the fact that Zₙ_{²}* has φ(n)n elements.

Theorem 3 Let a, x, y, n be as specified in the common input of protocol SQ2. The protocol has the following properties soundness property:

Soundness If (27) does not hold for the common input values, then Alice cannot convince Bob to accept her proof with probability greater than

$$\frac{n - φ ( n ) + 1}{n} {.}^{4}$$

Proof Suppose that (27) does not hold whereas Bob has accepted Alice's proof. Since x is in the orbit of a, so it is the second congruence of (27) that does not hold. We can denote z=logₐx and

∃ξ≠1:y≡ξa^{z}^{²}(mod n²). (28)

Since Bob accepts the proof, he sees the following two congruences (noticing (28) with x≡a^{z}):

C≡a^{r}x^{s}≡a^{r+sz}(mod n²),

R≡x^{r}y^{s}≡a^{(r+sz)z}ξ^{s}≡C^{z}ξ^{s}(mod n²). (29)

Since Alice has also proven R≡C^{k}(mod n²) for some k, we derive

C^{k-z}≡ξ^{s}(mod n²). (30)

On the other hand, in (29) logₐC∈(a) since x∈(a), so writing Orderₙ_{²}(a)=ln for some integer l|∈(n), we are allowed to rewrite (29) in the following linear congruence

logₐC≡r+sz(mod ln).

For each case of s=1, 2, . . . , ln, this linear congruence has a value for r, and so it has exactly ln distinct solution pairs. Note that these pairs are solved from the fixed C, a, x, and so they are independent from k and the fixed z. So the right hand, side of (30) is a constant for all cases of s=1, 2, . . . , ln; in particular, for the cases of s=1,2, we have:

1≡ξ²⁻¹≡ξ(mod n²).

This contradicts (28).

Since we derive the contradiction on the condition that R∈(C), the probability for Alice's successful cheating is therefore the same as that for R∉(C), the error probability of the subgroup membership proof (in Step 2). If Orderₙ_{³}(C) is a multiple of n, then the latter probability is bounded by 1/n. Thus, using the result of Lemma 2, we have (note that Pr[E|F] denotes the conditional probability)

$$\begin{matrix}Pr [ Alice Cheats ] = Pr [ R ∉ ⟨ C ⟩ \vert {Order}_{{n}^{2}} ( C ) \geq n ] Pr [ {Order}_{{n}^{2}} ( C ) \geq n ] + \\ Pr [ R ∉ ⟨ C ⟩ \vert {Order}_{{n}^{2}} ( C ) < n ] Pr [ {Order}_{{n}^{2}} ( C ) < n ] < \\ 1 / n + 1 - φ ( n ) / n = \frac{n - φ ( n ) + 1}{n} . □\end{matrix}$$

1. A method by which a first computing entity can verify to a second computing entity that a value a(t) provided by the first computing entity to the second computing entity is a member of the language, L(a,t,n) where
L(a,t,n)={a,t, a²^{^{t}}(modn)|t<n, gcd(a,n)=1), where n is an odd composite integer having two distinct prime factors, a [symbol] Znₙ* of the full order and t<n, in which the first computing entity sends a set of values to the second computing entity during a run of a procedure of a plurality of rounds, each round being carried out by the first and second computing entities with respect to three of said series of values, denoted a, x, y, and in which round the first computing entity proves to the second computing entity by way of a proof that there exists a k for which x=a²^{^{k}}(modn) and y=a⁽²^{^{k}}⁾^{²} (modn), and which proof defines a new set of three values of the series by defining y=x if k in the current round is even or y=\sqrt{x} (modn) if k in the current round is odd,
this round of steps being successively repeated until the new set of values defined by a round of steps satisfy x=a² (modn).

2. The method of claim 1 in which the second computing entity verifies the values x and y received from the first computing entity [symbol] J+(n).

3. The method of claim 1 in which the second computing entity first verifies a(t) [symbol] J₊(n) and that a is not ≡±u(modn).

4. The method of claim 1 in which the proof comprises the first computing entity selecting a value z:x≡±a^{z}(modn), y≡±a^{z}^{²}(modn), the second computing entity choosing at random r<n, s<n and sending the value C=a^{r}x^{s}(modn) to the first computing entity, the first computing entity sending to the second computing entity the value R=C^{e}(modn), and the second computing entity accepting the verification if, and only if, the received value R is x^{r}y^{s}(modn).

5. The method of claim 1, including the computer implemented first step of verifying by data exchanges with the computing entities that n is an odd composite of two distinct primes to a desired confidence level.

6. The method of claim 1, including the computer implemented step of verifying a [symbol] Zₙ* of the full order.

7. A method by which a computing entity can provide that an RSA ciphertext M^{e} (modn) of a message M<n provided to another computing entity is verifiably decryptable in time t, where n=p.q, p and q being two distinct odd primes and e is relatively prime to φ(n), the method comprising the computer implemented steps of:
a) forming a(t)=a²^{^{t}}(mod n) and a^{e}(t)=(a(t))^{e}(modn), a not ≡±1(modn) and being a random element in Zₙ*;
b) forming TE(M,t)=a(t) M(modn),
c) sending the tuple (TE(M,t), a^{e}(t), e,a,t,n) to the other computer entity.

8. The method of claim 7 wherein the other computing entity on receiving the tuple from the computing entity verifies that, the RSA ciphertext m(modn) is decryptable from TE(M,t) in time t by confirming a^{e}(t) [symbol] L(a^{e}, t,n) by the method by which a first computing entity can verify to a second computing entity that a value a(t) provided by the first computing entity to the second computing entity is a member of the language, L(a,t,n) where
L(a,t,n)={a,t, a²^{^{t}}(modn)|t<n, gcd(a,n)=1), where n is an odd composite integer having two distinct prime factors, a [symbol] Znₙ* of the full order and t<n, in which the first computing entity sends a set of values to the second computing entity during a run of a procedure of a plurality of rounds, each round being carried out by the first and second computing entities with respect to three of said series of values, denoted a, x, y, and in which round the first computing entity proves to the second computing entity by way of a proof that there exists a k for which x=a²^{^{k}} (modn) and y=a⁽²^{^{k}}⁾^{²} (modn), and which proof defines a now set of three values of the series by defining y=x if k in the current round is even or y=\sqrt{x} (modn) if k in the current round is odd,
this round of steps being successively repeated until the new set of values defined by a round of steps satisfy x=a² (modn).

9. A method by which a computing entity can provide that an RSA signature M^{d}(modn) on a message M<n provided to another computer entity is verifiably releasable in time t, where n=p.q, p and q being distinct odd primes and d is relatively prime to φ(n), the method comprising the computer implemented steps of:
a) forming a(t)=a²^{^{t}} (modn) and a^{e}(t)=(a(t))^{e}(modn); a not being ≡±=(modn) and being a random element in Zₙ*;
b) forming TS(M,t)=a(t)M^{d}(modn);
c) sending the tuple (M,TS(m,t), a^{e}(t),e, a, t, n) to the other computing entity.

10. The method of claim 9 wherein the other computing entity on receiving the tuple from the computing entity verifies that the RSA signature M^{d}(modn) can be obtained from TS(M,t) in time t by confirming a^{e}(t) [symbol] L(a^{e},t,n) by the method of claim 1 and by confirming TE(M,t)^{e}≡a^{e}(t)M^{e}(modn).

11. A computing entity comprising:
a data processing equipment
a memory; and
a communications equipment,
said data processing equipment being configured so as to be capable of processing data according to a set of instructions stored in said memory;
said communications equipment configured so as to communicate data according to said set of instructions;
said set of instructions being such as to configure the computing entity to be capable of carrying out the computer implemented steps of the first computing entity of claim 1.

12. A computing entity comprising:
a data processing equipment
a memory; and
a communications equipment,
said data processing equipment being configured so as to be capable of processing data according to a set of instructions stored in said memory;
said communications equipment configured so as to communicate data according to said set of instructions;
said set of instructions being such as to configure the computing entity to be capable of carrying out the computer implemented steps of the second computing entity of claim 1.

13. A communication system including a system of at least co-operating computing entities one of each as claimed in claim 11 which are able to exchange data by way of a communications medium, and in which said communications medium includes one or more of any of the internet, local area network, wide area network, virtual private circuit or public telecommunications network.

14. A computer storage medium having stored thereon a computer program readable by a general-purpose computer, the computer program including instructions for said general purpose computer to configure it to be as the computing entity of claim 11.
